(19) United States
(12) Patent Application Publication
(10) Pub. No.: US 2012/0034876 A1
(43) Pub. Date: Feb. 9, 2012

(54) METHOD AND APPARATUS FOR VEHICLE-TO-VEHICLE COMMUNICATION

(75) Inventors: Junichi Nakamura, Kawasaki-shi (JP); Yasuhiro Shibata, Yokoham-shi (JP); Hideaki Kojima, Machida-shi (JP)

(73) Assignee: Kabushiki Kaisha TOSHIBA, Tokyo (JP)

(21) Appl. No.: 13/195,181

(22) Filed: Aug. 1, 2011

(30) Foreign Application Priority Data
Aug. 3, 2010 (JP) 2010-174806

(51) Int. Cl. H04W 4/00

(52) U.S. Cl. 455/66.1

(57) ABSTRACT

According to one embodiment, a vehicle-mounted apparatus includes a wireless communication unit, an authentication data acquisition unit, a data transmitting/receiving unit, and a controller. The authentication data acquisition unit is configured to perform an authentication process with a roadside apparatus, through the wireless communication unit, and thereby to acquire authentication data showing that the apparatus is authenticated in a specified area of a road. The data transmitting/receiving unit is configured to transmit and receive information containing the authentication data, to and from the vehicle-mounted apparatus mounted in any other vehicle. The controller is configured to control the data transmitting/receiving unit in accordance with the authentication data, causing the data transmitting/receiving unit to transmit and receive data other than the authentication data.

### CROSS-REFERENCE TO RELATED APPLICATIONS

This application is based upon and claims the benefit of priority from prior Japanese Patent Application No. 2010-174806, filed Aug. 3, 2010, the entire contents of which are incorporated herein by reference.

### FIELD

Embodiments described herein relate generally to a vehicle-to-vehicle communication technique that has a security function.

### BACKGROUND

In recent years, it has been proposed that a vehicle-to-vehicle communication technique should be developed, which uses electromagnetic waves in, for example, the 700-MHz or 5.8-GHz band, thereby achieving wireless communication between the apparatuses mounted in vehicles (hereinafter referred to “vehicle-mounted apparatuses”). The vehicle-to-vehicle communication enables the driver of any vehicle traveling on a road to obtain safety information, safety driving guidance and traffic safety data, via the vehicle-mounted apparatuses, from the vehicle-mounted apparatuses of the other vehicles traveling on the road.

More specifically, the vehicle-to-vehicle communication can give traffic information to the driver of a vehicle, for example at an intersection or in the shade of tall buildings where he or she cannot see ahead well. In addition, the communication enables the driver of any vehicle to receive, from the vehicle traveling immediately in front, various event data items, such as brake data, turn data and speed data. From these event data items, the driver of the vehicle can recognize the traffic state (including congestion) in front on the road.

In the vehicle-to-vehicle communication, an authentication process must be performed in order to accomplish a security function so that the vehicle-mounted apparatus of each vehicle may exchange the safety information, safety driving guidance and traffic safety data with only the authenticated vehicle-mounted apparatuses, thereby to prevent communication with the vehicle-mounted apparatuses of unidentified or inappropriate vehicles.

In practice, however, the authentication process may be difficult to perform through the wireless communication between the vehicle-mounted apparatuses. This is because immergence information must be transmitted at, for example, an intersection or on a congested road, and the communication traffic, including the communication for achieving the authentication process, should therefore be restricted as much as possible, because.

To be more specific, the time overhead of any vehicle-mounted apparatus will increase if the apparatus performs authentication process every time it receives immergence information, thereby to check the authenticity of the apparatus that has transmitted the information. Moreover, the authentication process is practically impossible with respect to a vehicle that is coming to and going from, for example, an intersection, within a short time. Particularly in a traffic jam, the vehicle-mounted apparatus of each vehicle needs to authenticate the vehicle-mounted apparatus of several other vehicles traveling nearby. Further, a single authentication process cannot predict when the vehicle from which the immergence information has been received will travel away. In view of this, a vehicle-to-vehicle communication technique is demanded, which can efficiently perform an authentication process for achieving a security function.

### BRIEF DESCRIPTION OF THE DRAWINGS

FIG. 1 is a block diagram explaining the configuration of a system according to an embodiment;

FIG. 2 is a diagram explaining the effect of vehicle-to-vehicle communication according to the embodiment;

FIG. 3 is a diagram explaining the relation the vehicle-to-vehicle communication according to the embodiment has with a traffic state;

FIG. 4 is a diagram explaining how the system according to the embodiment operates;

FIG. 5 is a flowchart explaining how a roadside apparatus according to the embodiment operates;

FIG. 6 is a flowchart explaining how a vehicle-mounted apparatus according to the embodiment operates;

FIG. 7 is a flowchart explaining how the vehicle-mounted apparatus according to the embodiment transmits information;

FIG. 8 is a flowchart explaining how the vehicle-mounted apparatus according to the embodiment receives information;

FIG. 9 is a timing chart explaining how a system according to the embodiment operates;

FIG. 10 is a flowchart explaining how a vehicle-mounted apparatus according to another embodiment operates; and

FIG. 11 is a flowchart explaining how a vehicle-mounted apparatus according to still another embodiment operates.

### DETAILED DESCRIPTION

In general, according to one embodiment, a vehicle-mounted apparatus includes a wireless communication unit, an authentication data acquisition unit, a data transmitting/receiving unit, and a controller. The authentication data acquisition unit is configured to perform an authentication process with a roadside apparatus, through the wireless communication unit, and thereby to acquire authentication data showing that the apparatus is authenticated in a specified area of a road. The data transmitting/receiving unit is configured to transmit and receive information containing the authentication data, to and from the vehicle-mounted apparatus mounted in any other vehicle. The controller is configured to control the data transmitting/receiving unit in accordance with the authentication data, causing the data transmitting/receiving unit to transmit and receive data other than the authentication data.

Embodiments will be described with reference to the accompanying drawings.

### [Configuration of the System]

A system according to this embodiment is a data communication system composed mainly of vehicle-mounted apparatuses 10A and 10B and a roadside apparatus 20. The apparatuses 10A and 10B are mounted in two vehicles, respectively. For convenience, the apparatus 10B mounted in one vehicle shall be regarded as communication partner to the apparatus 10A mounted in the other vehicle. The vehicle-mounted apparatuses 10A and 10B and the roadside apparatus 20 have wireless communication devices 11A, 11B and 21, respectively. Each of these wireless communication devices includes an antenna configured to received and transmit electric waves. The wireless communication devices 11A, 11B and 21 are designed to perform data communication in, for example, a narrowband wireless communication scheme known as Dedicated Short-Range Communication (DSRC). To be more specific, these wireless communication devices are used in vehicle-to-vehicle communication (VTVC) or road-to-vehicle communication (RTVC).

The vehicle-mounted apparatus 10A has a global positioning system (GPS) device 12A, a controller 13A, and a memory 14A. Similarly, the vehicle-mounted apparatus 10B has a Global Positioning System (GPS) device 12B, a controller 13B, and a memory 14B. The GPS devices 12A and 12B output position data items representing the present positions of the two vehicles in which the apparatuses 10A and 10B are mounted. The controllers 13A and 13B are constituted by a computer. Each of the controllers 13A and 13B can process information including authentication data, position data and event data (described later) and can control the other components of the vehicle-mounted apparatus. The memories 14A and 14B are controlled by the controllers 13A and 13B, respectively, and store the authentication data, position data and event data.

The controllers 13A and 13B control displays 30A and 30B that are provided outside the vehicle-mounted apparatuses 10A and 10B, respectively. That is, the controllers 13A and 13B cause the displays 30A and 30B to display the position data output from the GPS devices 12A and 12B and the event data received by the wireless communication devices 11A and 11B.

The vehicle-mounted apparatuses 10A and 10B may have not only the wireless communication devices 11A and 11B of DSRC type, respectively, but also wireless communication devices using infrared beams and performing data communication with each other.

### [Operation of the System]

How the system according to the embodiment will be explained.

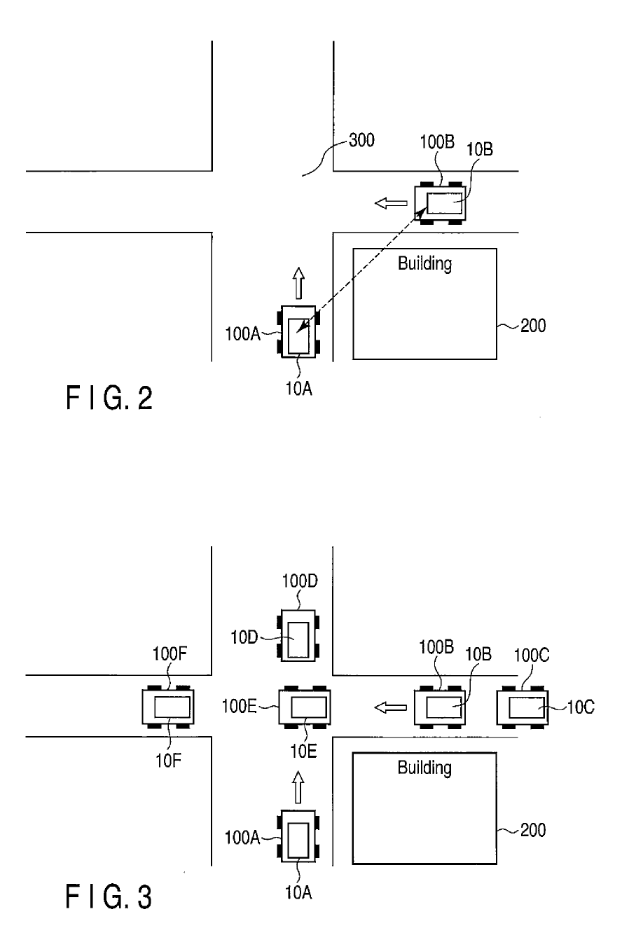

The system according to this embodiment is advantageous if used to achieve vehicle-to-vehicle communication at such an intersection 300 as shown in FIG. 2 and FIG. 3, which is a special area on a road. Vehicles 100A and 100B may be traveling at the intersection 300 as shown in FIG. 2. The drivers of the vehicles 100A and 100B may not see each other's vehicle, because of the building 200 standing at a corner of the intersection 300. In this case, the vehicle-to-vehicle communication between the vehicle-mounted apparatuses 10A and 10B can transmit to each other the information indicating that the vehicles 100A and 100B are approaching the intersection 300.

As shown in FIG. 3, several vehicles 100A to 100F may be caught in a traffic jam at the intersection 300 and in an area around the intersection 300. In this case, the system according to this embodiment can efficiently perform an authentication process between any two of the vehicles 100A to 100F.

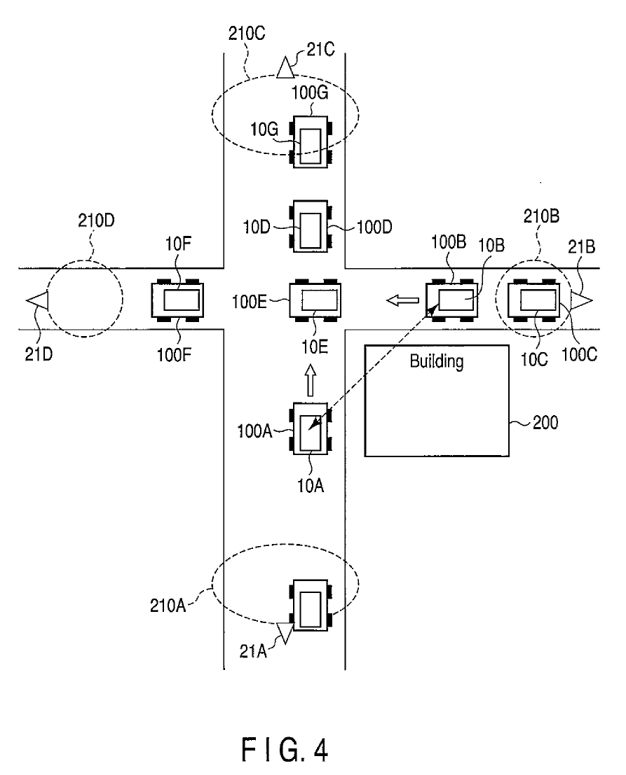

How the system according to the embodiment operates will be explained in detail, with reference to FIG. 4 to FIG. 9.

As shown in FIG. 4, roadside apparatuses 20 are installed at an intersection and in an area around the intersection. In FIG. 4, the roadside apparatuses 20 are not shown for convenience, and the wireless communication devices 21A to 21D incorporated in the respective roadside apparatuses 20A are shown. Alternatively, only one roadside apparatus 20 is installed at, for example, a position near the intersection, and the wireless communication devices 21A to 21D may communicate with this roadside apparatus 20. In either case, the wireless communication devices 21A to 21D perform road-to-vehicle communication (RTVC) by means of narrowband wireless communication, in limited areas 210A to 210D.

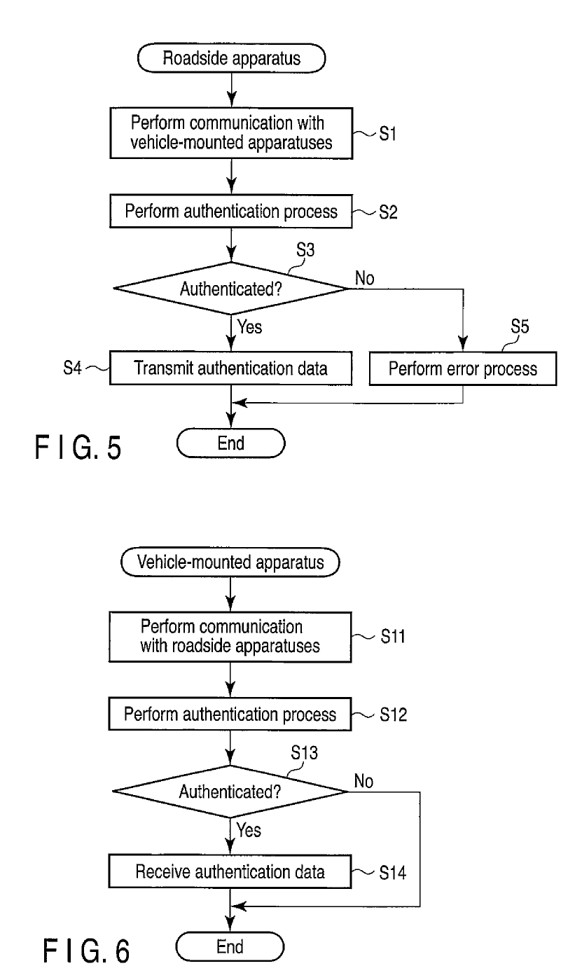

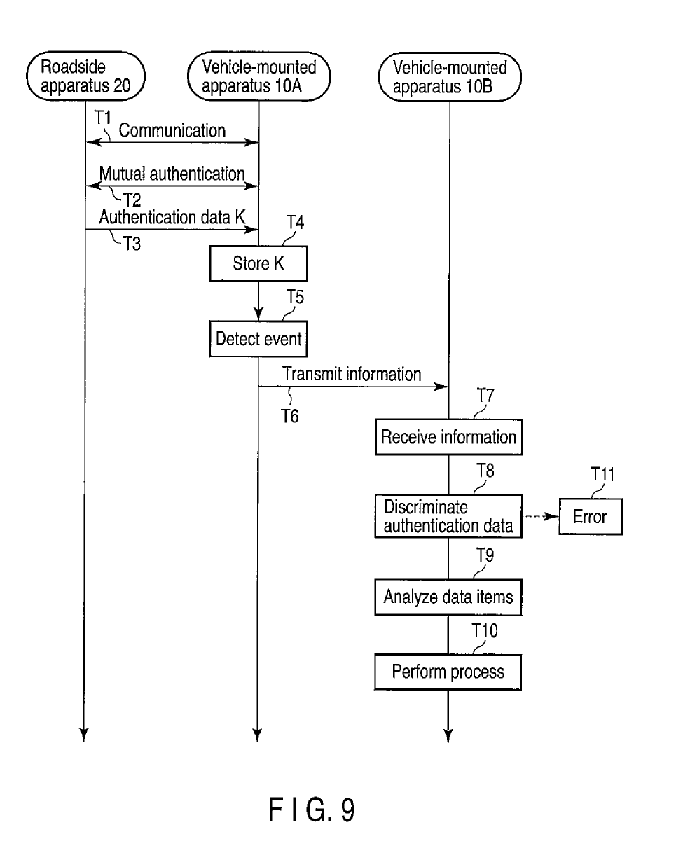

How an authentication process is performed to achieve the vehicle-to-vehicle communication (VTVC) between the roadside apparatus 20 and the vehicle-mounted apparatuses of the vehicles traveling will be explained with reference to the flowcharts of FIGS. 5 and 6 and the timing chart of FIG. 9. Hereinafter, “S” designates any step shown in the flowcharts, and “T” designates any timing shown in the timing chart.

The roadside apparatus 20 starts communicating with, for example, with the vehicle-mounted apparatus 10A of the vehicle 100A, by using the wireless communication devices 21A (S1, T1). The roadside apparatus 20 then performs the authentication process in a prescribed sequence (S2, T2). More precisely, the roadside apparatus 20 receives ID data from the vehicle-mounted apparatus 10A, and determines whether the ID data is genuine (S3). This embodiment is based on the assumption that the roadside apparatus 20 is authenticated because it can more easily acquire authenticity than each vehicle-mounted apparatus. The roadside apparatus 20 and any authenticated vehicle-mounted apparatus have apparatus authenticating function of a known type, and can therefore authenticate each other. (The apparatus authenticating function includes a function of managing the key data for authenticating the communication partner.)

The roadside apparatus 20 may determine that its communication partner, i.e., vehicle-mounted apparatus 10A, is an authenticated one. Then, the roadside apparatus 20 issues authentication data (K) that is valid in a specified area and transmits this data to the vehicle-mounted apparatus 10A (S4, T3). The “specified area” is such an intersection as shown in FIG. 4 and an area adjacent to the intersection. If the roadside apparatus 20 determines that the vehicle-mounted apparatus 10A is not an authenticated one (NO in S3), it performs a prescribed error process (S5) without issuing authentication data (K). The error process is, for example, a process of transmitting a message to the vehicle-mounted apparatus 10A, informing that the apparatus 10A cannot be authenticated.

Meanwhile, the vehicle-mounted apparatus 10A starts communicating with the roadside apparatus 20 via the wireless communication device 11A as shown in FIG. 6 (S11). The vehicle-mounted apparatus 10A receives the authentication data (K) from the roadside apparatus 20 if it has been determined to be authenticated by the roadside apparatus 20 (S12 to S14). In the vehicle-mounted apparatus 10A, the controller 13A receives the authentication data (K) though the wireless communication device 11A and stores the data (K) in the memory 14A.

The roadside apparatus 20 performs the authentication process also on the vehicle-mounted apparatus 10B of the vehicle 100B that has passed, for example, a narrowband wireless communication area 210B as shown in FIG. 4. Assume that the roadside apparatus 20 has authenticated the vehicle-mounted apparatus 10B. Then, in the vehicle-mounted apparatus 10B, the controllers 13B receives the authentication data (K) transmitted from the roadside apparatus 20, though the wireless communication device 11B, and stores the data (K) in the memory 14B. As described above, the authentication data (K) is data valid at such an intersection as shown in FIG. 4 and in an area adjacent to the intersection.

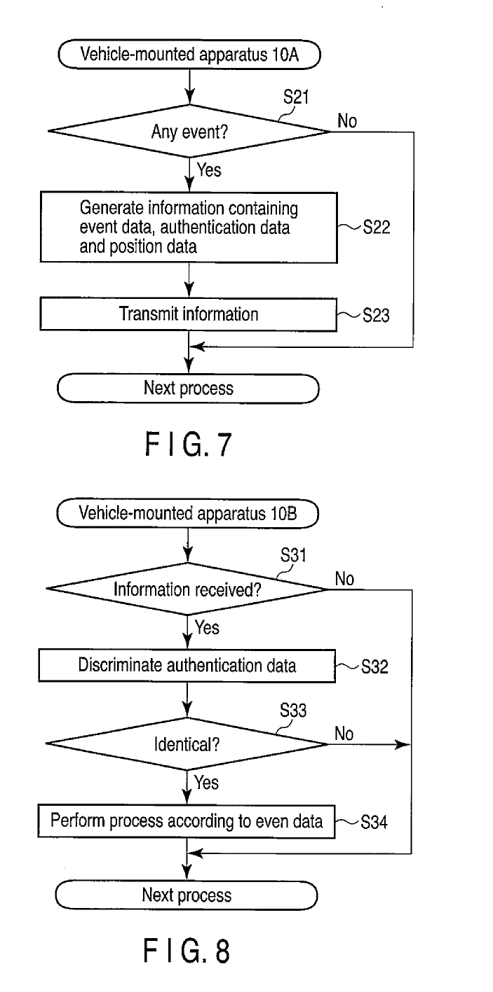

The sequence of the vehicle-to-vehicle communication between the vehicle-mounted apparatuses 10A and 10B, both authenticated, will now be explained in detail, with reference to the flowcharts of FIGS. 7 and 8.

Assume that the vehicle 100E comes to the intersection while the vehicle 100A is traveling toward the intersection as shown in FIG. 4. Also assume that the driver of the vehicle 100A therefore treadles on the brake pedal. That is, the event of pressing the brake pedal is assumed to have occurred as shown in FIG. 7 (YES in S21, T5). In the vehicle-mounted apparatus 10A, the controller 13A generates event data representing that the brake pedal has been pressed in the vehicle 100A.

Then, the controller 13A acquires the authentication data (K) stored in the memory 14A and also the position data from the GPS devices 12A, and generates transmission information containing the event data, authentication data (K) and position data (S22). The controller 13A transmits the transmission information trough the wireless communication device 11A (523, T6).

As shown in FIG. 4, the vehicle 100B is at the rear of the vehicle 100E. Suppose that the driver of the vehicle 100B cannot see the vehicle 100A approaching the intersection at this moment. As shown in FIG. 8, in the vehicle-mounted apparatus 10B of the vehicle 100B, the controller 13B receives, via the wireless communication device 11B, the transmission information containing the event data, authentication data (K) and position data transmitted from the vehicle-mounted apparatus 10A (YES in S31, T7).

The transmission information transmitted from the vehicle-mounted apparatus 10A of the vehicle 100A may be received not only by the vehicle-mounted apparatus 10B of the vehicle 100B, but also by the vehicle-mounted apparatuses 100 to 10F of the vehicle-mounted apparatuses 100C to 100F.

The vehicle-mounted apparatus 10B of the vehicle 100E extracts the authentication data (K) from the transmission information received, and discriminates the authentication data (S32, T8). More precisely, the controller 13B of the vehicle-mounted apparatus 10B first extracts the authentication data (K) stored in the memory 14B and then compares this authentication data (K) with the authentication data (K) of the vehicle-mounted apparatus 10A (S33).

If the authentication data (K) stored in the memory 14B is found identical to the authentication data (K) of the vehicle-mounted apparatus 10A, the controller 13B of the vehicle-mounted apparatus 10B determines that the vehicle-mounted apparatus 10A of the vehicle 100A has been authenticated (YES in S33). On the other hand, if the authentication data (K) stored in the memory 14B is not found identical to the authentication data (K) of the vehicle-mounted apparatus 10A, the controller 13B of the vehicle-mounted apparatus 10B determines that the vehicle-mounted apparatus 10A of the vehicle 100A has not been authenticated (T11, if NO in S33). In this case, the controller 13B invalidates all information received from the vehicle-mounted apparatus 10A of the vehicle 100A.

If the vehicle-mounted apparatus 10A is found authenticated, the controller 13B of the vehicle-mounted apparatus 10B determines that the information received is valid, and then perform a prescribed process (S34, T10). That is, the controller 13B extracts the position data and event data from the information it has received and analyzes these data items extracted (T9). More precisely, the controller 13B can confirm, from the result of analyzing the position data and event data, that the vehicle 100A is approaching the intersection and that the brake pedal has been treaded on in the vehicle 100A, though the driver of the vehicle 100B cannot see the vehicle 100A approaching the intersection.

The controller 13B may control the display 30B, thereby to cause the display 30B to display the result of analyzing the position data and the event data. In this case, the driver of the vehicle 100B can visually confirm that the vehicle 100A is approaching the intersection. The driver of the vehicle 100E can therefore slow down the vehicle 100B, not to collide with the vehicle 100A approaching the intersection.

Thus, the vehicle-to-vehicle communication enables the vehicle-mounted apparatuses of the vehicles traveling at or near an intersection and in the specified areas near the intersection can receive the position data and event data from one another. The vehicle-mounted apparatus of each of these vehicles therefore analyzes the position data and even data contained in the information it has received, thereby detecting any other vehicle approaching the intersection. Note that the event data is not limited to brake data, and includes turn data and speed data.

Each vehicle-mounted apparatus analyzes the information received by means of the vehicle-to-vehicle communication, first finding any other vehicle approaching the intersection and the traveling state thereof, and then informing the driver of the vehicle of the other vehicle that is approaching the intersection and the traveling state thereof. This helps the driver to achieve safety driving. Further, each vehicle-mounted apparatus can give caution to the driver of any vehicle or inform him or her of how vehicles are traveling in front and at the rear. This also assists the driver to drive in safety. Moreover, if traffic congestion often occurs in the specified area, the vehicle-mounted apparatus of each vehicle analyzes the information it has received, thereby calculating the average speed of any other vehicle existing in the specified area. This enables the driver of the vehicle to confirm how much the road is congested. Still further, if the specified area has a sharp turn, disabling the driver of any vehicle in the area to see the other vehicles traveling in front, the vehicle-mounted apparatus of each vehicle analyzes the information received, thereby enabling the driver to recognize any vehicle coming toward the vehicle.

The vehicle-mounted apparatuses that can perform the vehicle-to-vehicle communication with one another are authenticated by the roadside apparatus 20. Thus, the vehicle-to-vehicle communication between the vehicle-mounted apparatuses not authenticated, if attempted, is invalidated. This reliably ensures security. Since only the vehicle-mounted apparatuses authenticated in any specified area can exchange information with one another, they never use the information transmitted from the vehicle-mounted apparatus of any vehicle that exists outside the specified area. Conversely, the vehicle-mounted apparatuses existing outside the specified area are prevented from receiving invalid information.

In the authenticating method according to the embodiment, the authentication process is not performed in the specified area by means of vehicle-to-vehicle communication, but the result of the authentication process performed through road-to-vehicle communication is utilized. That is, road-to-vehicle communication is accomplished though a so-called “indirect vehicle-to-vehicle communication” performed as, “substituted authentication process.” In other words, an indirect mutual authentication can be achieved between vehicles. As a result, the authentication process between many vehicle-mounted apparatuses needs not be performed in the specified area, and the mutual authentication function is ensured between the vehicle-mounted apparatuses. The authentication process in the vehicle-to-vehicle communication can therefore be performed at an increased efficiency.

The roadside apparatus 20 may be configured to issue authentication data containing encryption data. More precisely, the transmitting-side vehicle-mounted apparatus (i.e., apparatus 10A) transmits transmission data encoded with the encryption data. The receiving-side vehicle-mounted apparatus (i.e., apparatus 10B) receives the transmission data. If the authentication data authenticates the transmission data, the receiving-side vehicle-mounted apparatus decodes the transmission data with the encryption key contained in the authentication data. The encryption data may be of a common key type or a public key type.

### Other Embodiment

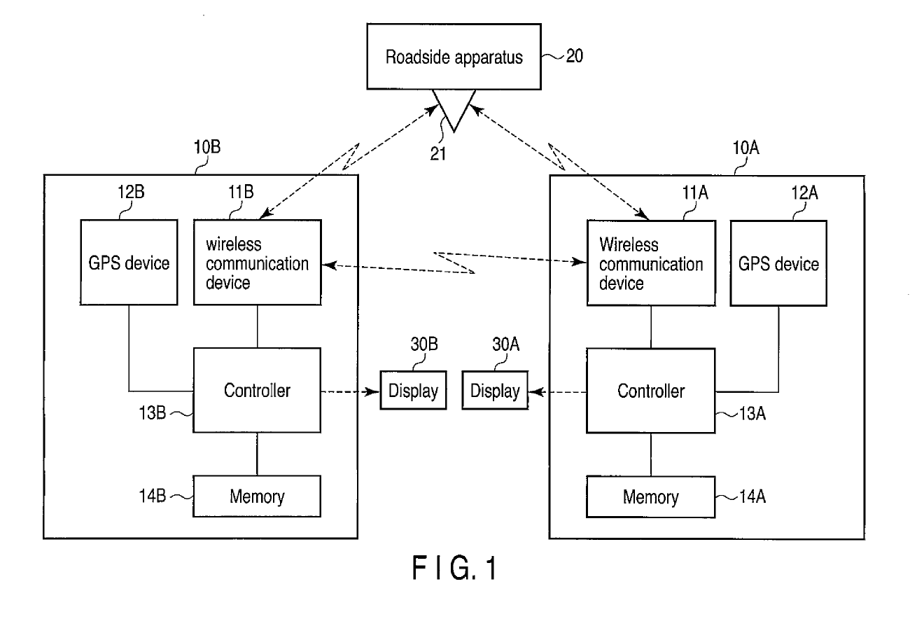

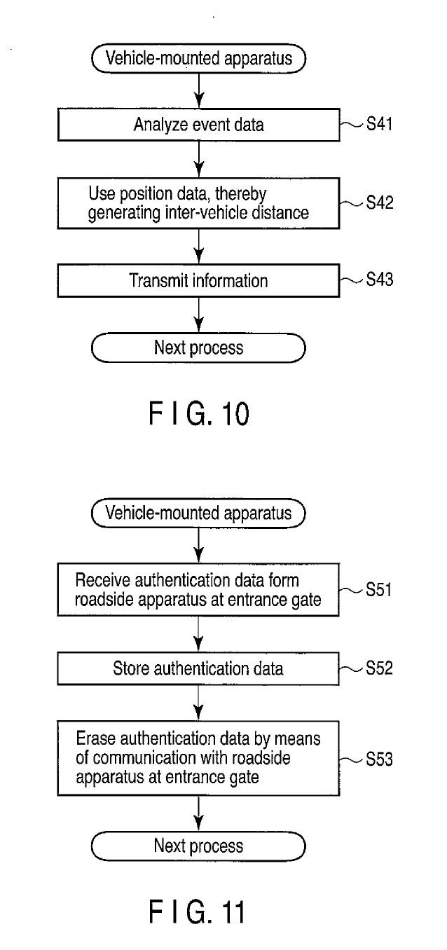

The flowcharts of FIGS. 10 and 11 explain another embodiment. The system configuration of the other embodiment is similar to the configuration shown in FIG. 1, and will not be described. The authentication process performed in the road-to-vehicle communication is similar to the process shown in the flowcharts of FIGS. 5 and 6, and will not be explained, either.

How the system according to this embodiment operates will be explained with reference to the flowchart of FIG. 10, on the assumption that the specified area is one where the driver of any vehicle on a greatly arched bridge cannot see ahead well.

Two vehicles 100A and 100B may be traveling on the arched bridge, the vehicle 100b at the rear of the vehicle 100A. In this case, the communication device 11A incorporated in the vehicle-mounted apparatus 10A of the vehicle 100A transmits transmission data containing authentication data (K), position data and event data. The vehicle-mounted apparatus 10B of the vehicle 100B traveling at the rear of the vehicle 100A receives the transmission data via its communication device 11B. On the basis of the authentication data (K), the vehicle-mounted apparatus 10B performs such indirect mutual authentication as described above.

The vehicle-mounted apparatus 10B of the vehicle 100B traveling behind the vehicle 100A may determine that the vehicle-mounted apparatus 10A of the vehicle 100A is authenticated. Then, the vehicle-mounted apparatus 10B analyzes the event data contained in the authentication data received, acquiring the speed data about the vehicle 100A traveling in front (Step S41). The vehicle-mounted apparatus 10B further uses the position data about the vehicle 100A, calculating the distance between the vehicles 100BA and the vehicle 100A traveling in front (Step S42). The vehicle-mounted apparatus 10B causes the display 30B to display the speed of the vehicle 100A and the inter-vehicle distance so calculated (Step S43). The driver of the vehicle 100B can therefore confirm the existence of the vehicle 100A, the speed thereof and the inter-vehicle distance. This enables the driver of the vehicle 100B can therefore infer the degree of traffic jam on the arched bridge on which the driver of any vehicle cannot see ahead well.

As the vehicle-mounted apparatus 10B of the vehicle 100B traveling at the rear of the vehicle 100A transmits and receives data in this vehicle-to-vehicle communication, it can determine the traffic state in a specified area, such as an arched bridge on which the driver of any vehicle cannot see ahead well. If the vehicle 100A is traveling slowly and if the inter-vehicle distance is therefore relatively long with respect to the vehicle 100B traveling behind, the driver of the vehicle 100B can know that the bridge is considerably congested. On the other hand, the driver of the vehicle 100A can confirm the traffic jam in the specified area, e.g., arched bridge, from the speed of the vehicle 100B traveling behind and the inter-vehicle distance.

How the system operates will be explained, on the assumption that the specified area extends from an entrance to a toll road to an exit thereof.

As the vehicle 100A, for example, passes the entrance gate of the toll road, the roadside apparatus 20 installed at the entrance gate determines whether the vehicle-mounted apparatus 10A is authenticated or not. If the roadside apparatus 20 determines that the vehicle-mounted apparatus 10A is authenticated, it transmits the authentication data, which the vehicle-mounted apparatus 10A receives (Step S51). In the vehicle-mounted apparatus 10A, the controller 13A stores the authentication data in the memory 14A (Step S52).

The vehicle-mounted apparatus 10A of the vehicle 100A can exchange position data and event data with, for example, the vehicle-mounted apparatus 10b of the vehicle 100B, which has also received the same authentication data from the roadside apparatus 20, by virtue of the vehicle-to-vehicle communication described above.

As the vehicle 100A passes the exit gate of the toll road, the vehicle-mounted apparatus 10A communicates with the roadside apparatus 20 installed at the exit gate. This roadside apparatus 20 transmits a command to the vehicle-mounted apparatus 10A, instructing that the authentication data the apparatus 10A received at the entrance gate should be erased. In the vehicle-mounted apparatus 10A, the authentication data is therefore erased from the memory 14A (Step S53).

By virtue of the road-to-vehicle communication, the vehicle-mounted apparatus 10A of the vehicle 100A can erase the authentication data received from the roadside apparatus 20 after the vehicle 100A has traveled out of the specified area of the highway or toll road (e.g., area extending from the entrance gate to the exit gate). Therefore, the vehicle-mounted apparatus 10A of the vehicle 100A can invalidate the vehicle-to-vehicle communication with the vehicle-mounted apparatus 10B of the vehicle 100B after the vehicle 100A has left the highway or toll road and entered an ordinary road.

Highways or toll roads do not always stray far away from local roads. Some are very near to local roads. If this is the case, the vehicle-mounted apparatus of a vehicle that has just exited the highway or toll road and come into a local road may receive information from the vehicle-mounted apparatuses of vehicles traveling on the highway or toll road if it keeps storing the authentication data it has received on the highway or toll road. This information is not related to the traffic state of the local road the vehicle is now traveling on, and is therefore not necessary at all. The receipt of the unnecessary information is avoided by erasing the authentication data received from the roadside apparatus 20.

The function of erasing authentication data, according to this embodiment, is useful in a parking lot where an area extending from the entrance and exit can be designated as a specified area. In this case, the vehicle-to-vehicle communication can be validated while the vehicle remains in the parking lot, and can be invalidated once the vehicle has left the parking lot and come into a local road.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An data communication apparatus to be mounted in a vehicle, comprising:
a wireless communication unit:
an authentication data acquisition unit configured to perform an authentication process with a roadside apparatus, through the wireless communication unit, thereby to acquire authentication data showing that the apparatus is authenticated in a specified area of a road;
a data transmitting/receiving unit configured to transmit and receive information containing the authentication data, to and from the vehicle-mounted apparatus mounted in any other vehicle; and
a controller configured to control the data transmitting/receiving unit in accordance with the authentication data, causing the data transmitting/receiving unit to transmit and receive data other than the authentication data.

2. The apparatus of claim 1, wherein the controller determines whether the authentication data acquired by the authentication data acquisition unit is identical to the authentication data transmitted from a vehicle-mounted apparatus mounted in any other vehicle, validates the transmission and receipt of the data other than the authentication data if the authentication data acquired is identical to the authentication data transmitted, and invalidates the transmission and receipt of the data other than the authentication data if the authentication data acquired is not identical to the authentication data transmitted.

3. The apparatus of claim 1, further comprising a data processing unit configured to process the data received by the data transmitting/receiving unit, and to generate, from the data received, data representing a traffic state in the specified area.

4. The apparatus of claim 1, wherein the data transmitting/receiving unit transmits and receives, as data other than the authentication data, position data representing the position of the apparatus and event data representing the state of the vehicle.

5. The apparatus of claim 3, wherein the data processing unit uses position data and event data received by the data transmitting/receiving unit and representing the position and state of the vehicle, respectively, thereby to generate data representing the distance between the vehicle and another vehicle, the proximity thereto or traffic congestion state in the specified area.

6. The apparatus of claim 1, wherein the authentication data acquisition unit acquires the authentication data and encryption data contained in the authentication data; the data transmitting/receiving unit receives data encrypted with the encryption data contained in the authentication data; and the controller uses the encryption data acquired by the authentication data acquisition unit, thereby to decrypt encrypted data transmitted from the other vehicle-mounted apparatus authenticated on the basis of the authentication data.

7. The apparatus of claim 1, wherein if the specified area is a toll road, the authentication data acquisition unit acquires the authentication data and stores the authentication data in a memory at the entrance to the toll road and erases the authentication data from the memory at the exit of the toll road.

8. A vehicle-to-vehicle communication system designed to perform wireless data communication between vehicle-mounted apparatuses mounted in vehicles, the system comprising a roadside unit configured to transmit authentication data representing the authenticity the vehicle-mounted apparatuses have in a specified area of a road, to the vehicle-mounted apparatuses by means of the wireless data communication,
wherein each of the vehicle-mounted apparatuses has:
a unit configured to receive the authentication data transmitted from the roadside apparatus;
a data transmitting/receiving unit configured to transmit and receive information containing the authentication data, to and from a vehicle-mounted mounted in any other vehicle; and
a controller configured to control the data transmitting/receiving unit in accordance with the authentication data, causing the data transmitting/receiving unit to transmit and receive data other than the authentication data.

9. The system of claim 8, wherein determines whether the authentication data acquired by the authentication data acquisition unit is identical to the authentication data transmitted from a vehicle-mounted apparatus mounted in any other vehicle, validates the transmission and receipt of the data other than the authentication data if the authentication data acquired is identical to the authentication data transmitted, and invalidates the transmission and receipt of the data other than the authentication data if the authentication data acquired is not identical to the authentication data transmitted.

10. A vehicle-to-vehicle communication method for use in a vehicle-to-vehicle communication system designed to perform wireless data communication between vehicle-mounted apparatuses mounted in vehicles, the method comprising:
receiving authentication data representing the authenticity the vehicle-mounted apparatuses have in a specified area of a road, by means of the wireless data communication;
transmitting and receiving information containing the authentication data, to and from a vehicle-mounted apparatus mounted in any other vehicle; and
controlling the transmission and receipt of data other than the authentication data in accordance with the authentication data.

11. A non-transitory, computer-readable medium having thereon a computer program which is executable by a computer incorporated in a vehicle-mounted apparatus mounted in a vehicle and which controls the computer to execute functions of:
receiving authentication data representing authenticity the vehicle-mounted apparatus has in a specified area of a road, from a roadside apparatus by means of wireless communication;
transmitting and receiving information containing the authentication data, to and from a vehicle-mounted apparatus mounted in any other vehicle; and
controlling the transmission and receipt of data other than the authentication data in accordance with the authentication data.
